(19) United States
(12) Patent Application Publication
(10) Pub. No.: US 2012/0267180 A1
(43) Pub. Date: Oct. 25, 2012

(54) AGRICULTURAL HARVESTER WITH AIR CONDUIT

(76) Inventors: Xijun Wang, Bettendorf, IA (US); Yizhong Yang, Jiamusi (CN); Alan D. Sheidler, Moline, IL (US); Sanghoon Suh, Bettendorf, IA (US); Chunling Cao, Jiamusi City (CN)

(21) Appl. No.: 13/093,813

(22) Filed: Apr. 25, 2011

(51) Int. Cl. B60K 11/00

(52) U.S. Cl. 180/68.1

(57) ABSTRACT

An agricultural harvester (100) has a chassis (106) supported on a plurality of wheels (110) for travel over the ground; a harvesting implement (104) supported on the front of the chassis (106); an internal combustion engine (108) disposed on the chassis (106) behind the harvesting implement (104); a radiator (112) coupled to the internal combustion engine (108) to transfer heat from engine coolant to ambient air; a fan (109) disposed to draw a flow of cooling air through the radiator having a first flow rate; and a conduit (114) configured to conduct substantially the entire first flow rate of air to the radiator (112). The conduit defines a lower air-impermeable enclosure surrounding the inlet of the radiator fixed to an upper enclosure comprising a plurality of screen walls for passing substantially the entire flow of cooling air therethrough.

### FIELD OF THE INVENTION

The invention relates to machines for harvesting crops. In particular it relates to systems for conducting clean cooling air to such machines.

### BACKGROUND OF THE INVENTION

Agricultural harvesters are machines designed for travel through an agricultural field harvesting crops. Agricultural harvesters typically include a vehicle including a chassis driven by an internal combustion engine. The chassis is supported on wheels or tracks that travel through the agricultural field. The agricultural harvester typically includes an implement disposed at the front of the vehicle that harvests the crop by severing the crop from the ground and sending the crop to the vehicle itself. The vehicle may also include threshing, separating, or cleaning elements in the vehicle itself. These elements further separate the crop from unwanted plant material. Typically the harvester also includes a conveyor to carry the crop to a bin that is also supported on the chassis.

The agricultural fields in which agricultural harvesters operate are often dirty and filled with light plant material, such as leaves, that are stirred up by the vehicles operation and carried in the air. This plant material must be separated from the cooling air that is provided to the internal combustion engine. To do this, screens are often placed in front of the radiators to prevent the flow of light plant materials from becoming stuck in the radiator. This plant material reduces the flow of cool air to the radiator and may cause the engine to overheat. It is important that the screens are large enough to pass sufficient air for cooling the radiator even in dirty environments.

The internal combustion engines for agricultural harvesters must be properly shielded to reduce the amount of ambient noise generated by the harvester that would otherwise disturb the operator or people in the environment in which the harvester operates. Reducing the noise is a continuing challenge for manufacturers of agricultural harvesters and other or vehicles.

What is needed is an agricultural harvester with improved cooling and reduced noise. It is an object of this invention to provide such an agricultural harvester.

### SUMMARY OF THE INVENTION

In accordance with a first aspect of the invention, an agricultural harvester is provided that comprises a chassis supported on a plurality of wheels for travel over the ground; an implement for harvesting crop plants supported on the front of the chassis, an internal combustion engine disposed on the chassis behind the implement; a radiator coupled to the internal combustion engine to transfer heat from engine coolant to ambient air; a fan disposed to draw a flow of cooling air through the radiator having a first flow rate, and a conduit configured to conduct substantially the entire first flow rate of air to the radiator, wherein the improvement comprises the conduit defining a lower enclosure surrounding the inlet of the radiator and blocking substantially all air flow to the radiator except through an upwardly facing air inlet, and an upper enclosure having a plurality of screen walls for passing substantially the entire first flow rate of cooling air therethrough and having a downwardly facing air outlet, wherein the upwardly facing air inlet and the downwardly facing air outlet are fixed together to conduct substantially the entire first flow rate of air therethrough.

The upper enclosure may be generally rectangular, and may be defined by a plurality of walls including a screen top wall and a plurality of screen side walls. The upper enclosure may be curved and generally oval in cross-section. The upper enclosure may be formed entirely of screen walls and may have no air impermeable walls. Alternatively, a top wall of the enclosure may be air-impermeable. A bottom wall of the lower enclosure may have a drain for draining water. A hinge may be fixed to the lower enclosure adjacent to an edge of the radiator. One or more latch members may be provided in a vertical orientation along a vertical edge of the air conduit.

### BRIEF DESCRIPTION OF THE DRAWINGS

FIG. 1 is a side view of an agricultural harvester in accordance with the present invention.

FIG. 2 is a perspective view of the engine, radiator and air conduit of the agricultural harvester of FIG. 1 with the remaining portions of the agricultural harvester removed for convenience of illustration.

FIG. 3 is a perspective view of the inside of the air conduit of the foregoing Figures.

FIG. 4 is a perspective view of the outside of the air conduit of the foregoing Figures.

### DESCRIPTION OF THE PREFERRED EMBODIMENT

Referring to the Figures, an agricultural harvester 100 comprises a self-propelled vehicle 102, supporting a harvesting implement 104 on the front end of the vehicle. The self-propelled vehicle 102 includes a chassis 106 on which an internal combustion engine 108 is mounted. The internal combustion engine 108 drives a plurality of wheels 110 that support the chassis 106 for movement over the ground. A radiator 112 is mounted in front of the internal combustion engine 108 to cool the liquid coolant in the engine. A conduit 114 is disposed in front of the radiator 112 to conduct air to the front of the radiator. And operator compartment 116 is disposed at the front of the vehicle above the harvesting implement 104 and faces forward. A conveyor 118 carries the cut crop material upward from the harvesting implement 104 to a cleaning bed 120 on which the crop is dropped. After being cleaned on the cleaning bed 120 the crop is conveyed rearward into a crop bin 122.

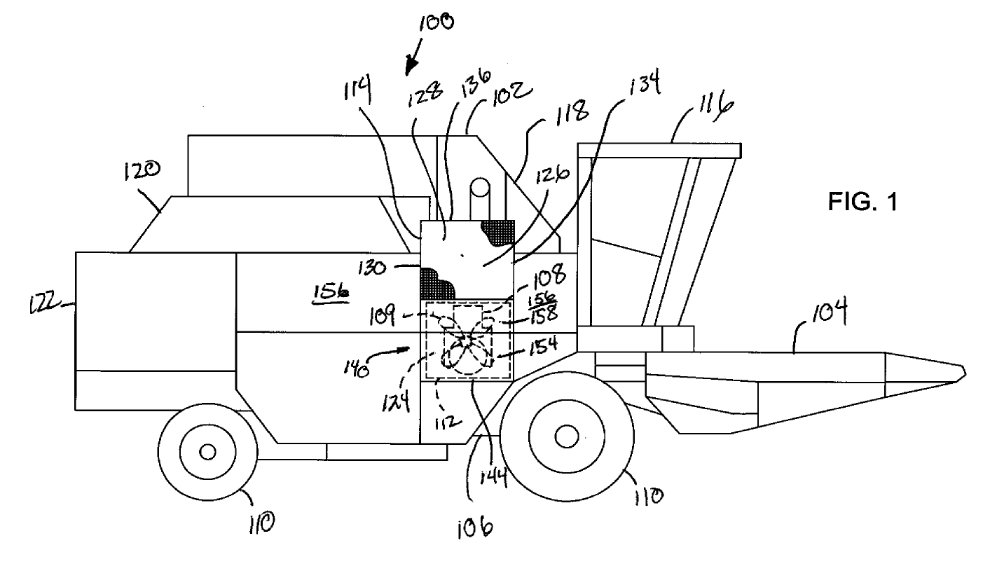

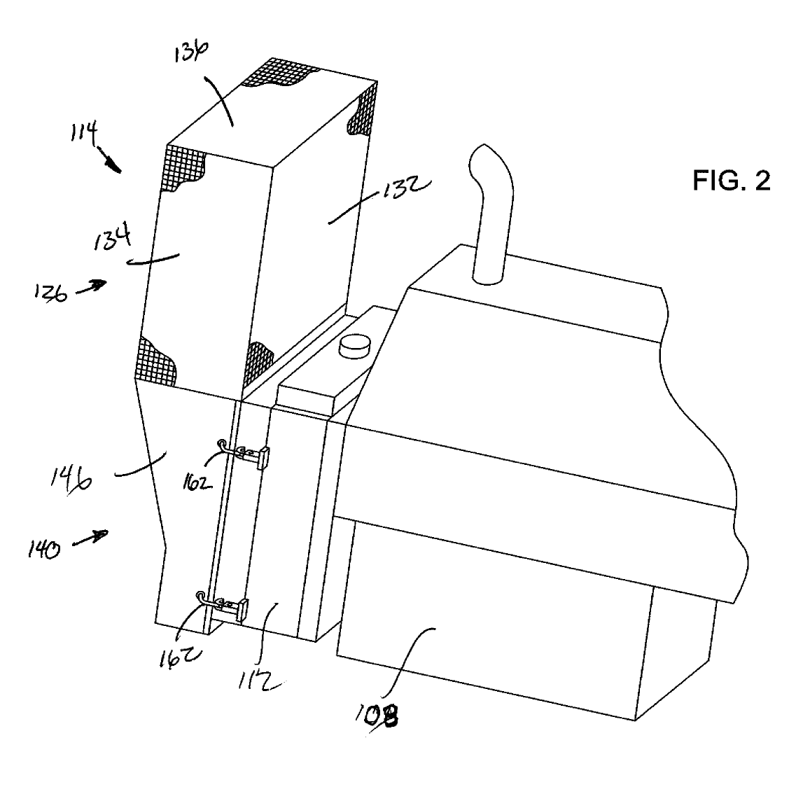

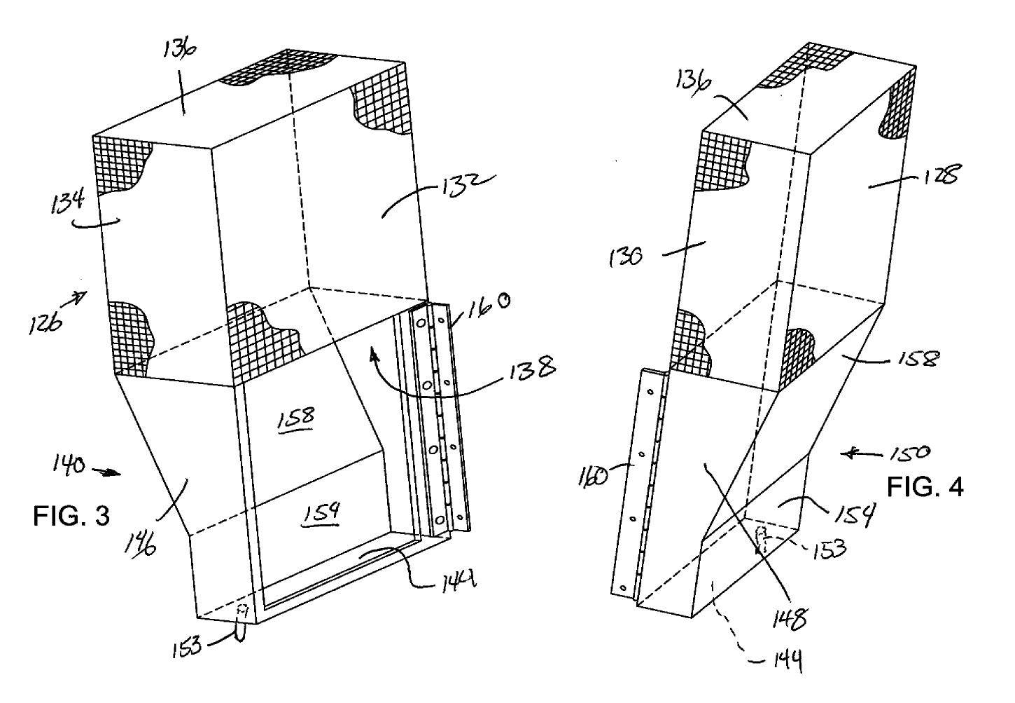

The internal combustion engine 108 is arranged such that its engine extends transverse to the forward direction of travel of the agricultural harvester. The radiator is arranged such that the inlet surface 124 of its planar cooling core faces outwardly and in a transverse direction to the forward direction of travel of the agricultural harvester 100. The forward direction of travel is to the right (in FIG. 1).

The conduit 114 has an upper portion 126 that is in the form of a generally box-shaped enclosure having an open bottom 138. Upper portion 126 is made of five generally vertical side walls 128, 130, 132, 134, and a top wall 136 that is generally flat and horizontal. All four side walls 128, 130, 132, 134 and the top wall 136 are comprised of screen material. All five walls and are air permeable to permit the passage of ambient air therethrough. All the air pulled into the upper portion 126 of the conduit 114 is conveyed downward through the open bottom 138 of the upper portion 126. The open bottom 138 of the upper portion functions as an air outlet of the upper portion. The five walls 128, 130, 132, 134, and 136 and the open bottom 138 define the six walls of a rectangular parallelepiped.

The conduit 114 also has a lower portion 140 in the form of a generally box-shaped enclosure that extends around and encloses the inlet 142 of the radiator. The lower portion 140 includes a bottom wall 144 that is generally flat and horizontal. The bottom wall 144 is coupled to the horizontal bottom edge of the radiator 112 inlet. The lower portion 140 also includes two side walls 146, 148 that are generally flat and vertical. The side walls 146, 148 are coupled to opposing vertical side edges of the inlet of radiator 112. A third side wall 150 is disposed directly in front of and facing the inlet of radiator 112. Side wall 150 is fixed to outer edges of side walls 146, 148 to define a four sided enclosure that encloses substantially the entire front face face of the radiator inlet, such that an air inlet 152 is defined at the top of the lower portion 140 between the top edges of side walls 146, 148 and 150, and the top horizontal edge of the inlet of radiator 112. The air inlet 152 at the top of the lower portion 140 is fixed to and receives substantially all the air from the upper portion 126 and communicates that air to the inlet of the radiator 112. The side walls 146, 148, 150 and bottom wall 144 of lower portion 140 are substantially impermeable to air. The side walls 146, 148, 150 and bottom wall 144 prevent substantially all air other than the ambient air passing into the upper portion 126 from being drawn into the radiator inlet.

Bottom wall 144 has a drain 153 with a small cross-sectional area that permits water to drain out of the bottom of conduit 114.

Side wall 150 is disposed in front of and extends over substantially the entire face of the inlet of radiator 112. As internal combustion engine 108 runs it generates noise. This noise is carried out of the engine compartment through the core of radiator 112. The sound waves that comprise the noise impact the inside surface of side wall 150 and are substantially dissipated by impacting inside surface of side wall 150. The residual sound waves that are reflected off side wall 150 are dissipated against side walls 146, 148 and bottom wall 144.

Side wall 150 flares outward away from radiator 112 as it extends upward. It has a lower portion 154 that is generally vertical and parallel to the side 156 of agricultural harvester 100. An outwardly tapering portion 158 that flares away from the vertical side 156 of agricultural harvester 100 is disposed above this lower portion 154. The upper edge of side wall 150 is fixed to the bottom edge of side wall 128 of the upper portion 126. This outward taper provides a larger space in lower portion 140 to permit air to pass into radiator 112.

Side wall 146 of the lower portion of conduit 114 is preferably vertical and coplanar with side wall 134 of upper portion 126. The upper edge of side wall 146 is preferably fixed to the lower edge of side wall 134.

Side wall 148 of the lower portion of conduit 114 is preferably vertical and coplanar with side wall 130 of upper portion 126. The upper edge of side wall 148 is preferably fixed to the lower edge of side wall 130.

A hinge 160 is fixed to an edge of side wall 148 adjacent to one side of radiator 112. The hinge is fixed to the side of agricultural harvester 100 permitting conduit 114 to pivot away from the front or radiator 112 about the vertical axis defined by the hinge 160.

Two latches 162 are provided to couple side wall 146 to the side of agricultural harvester 100. These latches are configured to hold conduit 114 against radiator 112 when latched, and to permit conduit 114 to swing outward about hinge 160 when released. The hinge and latches permit the operator to access the inlet surface of radiator 112 for cleaning or maintenance.

Having described the preferred embodiment, it will become apparent that various modifications can be made without departing from the scope of the invention as defined in the accompanying claims.

1. An agricultural harvester (100) comprises a chassis (106) supported on a plurality of wheels (110) for travel over the ground; a harvesting implement (104) supported on the front of the chassis (106); an internal combustion engine (108) disposed on the chassis (106) behind the harvesting implement (104); a radiator (112) coupled to the internal combustion engine (108) to transfer heat from engine coolant to ambient air; a fan (109) disposed to draw a flow of cooling air through the radiator having a first flow rate; and a conduit configured to conduct substantially the entire first flow rate of air to the radiator;
wherein the improvement comprises the conduit defining a lower enclosure surrounding the inlet of the radiator and blocking substantially all air flow to the radiator except through an upwardly facing air inlet of the lower enclosure, and an upper enclosure comprising a plurality of screen walls for passing substantially the entire first flow rate of cooling air therethrough and having a downwardly facing air outlet, wherein the upwardly facing air inlet and the downwardly facing air outlet are fixed together to conduct substantially the entire first flow rate of air therethrough.

2. The agricultural harvester of claim 1, the improvement further comprising the upper enclosure may be generally rectangular, and may be defined by a plurality of walls including a screen top wall and a plurality of screen side walls.

3. The agricultural harvester of claim 1, the improvement further comprising the upper enclosure being formed entirely of screen walls and having no air impermeable walls.

4. The agricultural harvester of claim 1, the improvement further comprising a bottom wall of the lower enclosure having a drain for draining water.

5. The agricultural harvester of claim 1, the improvement further comprising a hinge fixed to the lower enclosure adjacent to an edge of the radiator.

6. The agricultural harvester of claim 1, the improvement further comprising one or more latch members provided in a vertical orientation along a vertical edge of the air conduit.

7. The agricultural harvester of claim 1, the improvement further comprising the walls of the upper enclosure defining a regular parallelepiped.

8. The agricultural harvester of claim 1, the improvement further comprising the walls of the upper enclosure being disposed completely above the radiator inlet.
